(19) United States
(12) Patent Application Publication
(10) Pub. No.: US 2015/0058719 A1
(43) Pub. Date: Feb. 26, 2015

(54) METHOD FOR FORMING MULTI-FONT LIBRARY AND METHOD FOR DISPLAYING DIFFERENT FONTS USING MULTI-FONT LIBRARY

(71) Applicants: Peking University Founder Group Co., Ltd., Beijing (CN); Beijing Founder Electronics Co., Ltd., Beijing (CN); Founder Information Industry Group, Beijing (CN)

(72) Inventors: Yujun Gao, Beijing (CN); Fang Liu, Beijing (CN)

(21) Appl. No.: 14/091,927

(22) Filed: Nov. 27, 2013

(30) Foreign Application Priority Data
Aug. 20, 2013 (CN) 201310364773.3

(51) Int. Cl. G06F 17/21

(52) U.S. Cl. CPC G06F 17/214
USPC 715/269

(57) ABSTRACT

A method for forming a multi-font library can include extracting characters from a plurality of standard font libraries defined in existing international or national coding standards; configuring at least one customized code for each of the extracted characters, the number of customized codes of the each character is equal to the number of fonts of the character and the customized codes correspond to the fonts in a one-to-one manner; and storing the extracted characters and the customized codes thereof to form the multi-font library. An apparatus for forming a multi-font library, and a method and apparatus for displaying different fonts by using the multi-font library are correspondingly provided. The formed multi-font library is capable of storing and displaying characters using different fonts, and consumes less storage capacity as compared with the prior solution of displaying a plurality of fonts by using a plurality of font libraries.

### BACKGROUND

The present document relates to the field of computer character information processing, and in particular to a method and apparatus for forming a multi-font library, and a non-transitory computer-readable storage medium therefor.

### DESCRIPTION OF THE PRIOR ART

In all prevailing information systems and operating systems, if a user desires to display different fonts in the same text, different font libraries need to be used and switching therebetween is involved. This is because a standard font library is capable of storing and displaying only one font. For example, the SimSun font library displays only the SimSun font, the SimHei font library displays only the SimHei font, and the KaiTi font library only displays the KaiTi font, and so on.

With respect to some customized documents, multiple different fonts may need to be displayed in one paragraph, for example, customized Chinese characters “ [symbol] ”. When different fonts need to be displayed, different font libraries have to be selected. If a desired font library is unavailable, the library needs to be downloaded and installed, which is a complicated and time-consuming process. In addition, display of such customized characters imposes higher requirements on the storage capacity of mobile devices and requires highly customization, since storage of a plurality of font libraries consumes more storage capacity. On the contrary, mobile handheld devices using ISO or Android operating system have limited storage capacity, which is insufficient for pre-storing more font libraries. In this case, only a few font libraries are available for selection, and it is hard for the user to select a desired font library in the system. Even if the user selects one, only a limited number of fonts are available, and the user requirements may not be accommodated.

### SUMMARY

In view of the above defects in the prior art, embodiments of the present invention are directed to providing a method and apparatus for forming a multi-font library, and a program and non-transitory computer-readable storage medium therefor; and additionally providing a method and apparatus for displaying different fonts by using the multi-font library, and a non-transitory computer-readable storage medium therefor. The formed multi-font library is capable of storing and displaying characters using different fonts, and consumes less storage capacity as compared with the prior solution of displaying a plurality of fonts by using a plurality of font libraries.

In view of the above, the following technical solutions are employed:

In some implementations, a method for forming a multi-font library, includes the following steps:

A1. extracting a part of characters or all characters from a plurality of standard font libraries defined in existing international or national coding standards;

A2. configuring at least one customized code for each of the extracted characters, wherein the number of customized codes of the each character is equal to the number of fonts of the character and the customized codes correspond to the fonts in a one-to-one manner; and

A3. storing the extracted characters and the customized codes thereof to form the multi-font library.

Step A2 may include: in the characters extracted in step A1,

if there exists a character with the number of fonts being equal to 1, enabling the customized code of the character using the font in the multi-font library to be the same as a standard code of the character using the font in the standard font library; or

if there exists a character with the number of fonts being larger than 1, enabling each of the fonts of the character to correspond to a customized code, and enabling the customized code corresponding to each of the fonts of the character to be in one-to-one mapping relationship with a standard code of the character using the font in the standard font library.

The customized code corresponding to each of the fonts of the character with the number of fonts being larger than 1 may be formed by:

presetting a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and thereby deriving the corresponding customized code of each of the fonts of the character; or

randomly forming the customized code that is corresponding to each of the fonts of the character but different from the standard code of the character using the font in the standard font library.

The existing international coding standards may comprise ISO/IEC 10646:2003, and the existing national coding standards may comprise GB18030-2000 and GB13000.1-1993.

The multi-font library may be a TrueType font library, a PostScript font library, or a user-defined font library.

In some implementations, a method for displaying different fonts by using a multi-font library formed using the above-described method, includes the following steps:

B1. setting the multi-font library as a display font library on a newly created page;

B2. inputting a character sequence into the newly created page, and displaying at least one font with respect to the input character sequence;

B3. generating a corresponding standard coding sequence according to a standard code of each of characters in the input character sequence; and

B4. storing a one-to-one mapping relationship between a customized code of a character using each of fonts in the multi-font library and a standard code of the character using the font in the standard font library, and according to a one-to-one mapping relationship between a customized code of a font displayed with respect to each of the characters in the input character sequence in the multi-font library and a standard code of the character using the font in the standard font library, converting the standard coding sequence corresponding to the input character sequence into a customized coding sequence, and thereby displaying a character sequence comprising at least one font on the newly created page.

In some implementations, an apparatus for forming a multi-font library, includes: an extracting unit, a configuring unit, and a storing unit.

The extracting unit is configured to extract a part of characters or all characters from a plurality of standard font libraries defined in existing international or national coding standards.

The configuring unit is configured to configure at least one customized code for each of the extracted characters, wherein the number of customized codes of the each character is equal to the number of fonts of the character and the customized codes correspond to the fonts in a one-to-one manner.

The storing unit is configured to store the extracted characters and the customized codes thereof to form a multi-font library.

The configuring unit may be configured to: in the characters extracted by the extracting unit,

if there exists a character with the number of fonts being equal to 1, enable the customized code of the character using the font in the multi-font library to be the same as a standard code of the character using the font in the standard font library; or

if there exists a character with the number of fonts being larger than 1, enable each of the fonts of the character to correspond to a customized code, and enable the customized code corresponding to each of the fonts of the character to be in one-to-one mapping relationship with a standard code of the character using the font in the standard font library.

The configuring unit may be further configured to:

preset a function relation one-to-one corresponding to each of the fonts of the character, wherein in the function relation corresponding to each of the fonts, the standard code of the character using the font in the standard font library is an independent variable thereof of the function, and the customized code corresponding to the font is a dependent variable thereof; and thereby derive the corresponding customized code of each of the fonts of the character; or

randomly form the customized code that is corresponding to each of the fonts of the character but different from the standard code of the character using the font in the standard font library.

The existing international coding standards may comprise ISO/IEC 10646:2003, and the existing national coding standards may comprise GB18030-2000 and GB13000.1-1993.

The multi-font library may be a TrueType font library, a PostScript font library, or a user-defined font library.

In some implementations, an apparatus for displaying different fonts by using a multi-font library formed by the above-described apparatus, includes: a setting unit, an inputting unit, a standard coding sequence generating unit, and a code converting unit.

The setting unit is configured to set the multi-font library as a display font library on a newly created page.

The inputting unit is configured to input a character sequence into the newly created page, and display at least one font with respect to the input character sequence.

The standard coding sequence generating unit is configured to generate a corresponding standard coding sequence according to a standard code of each of characters in the input character sequence in a standard font library.

The code converting unit is configured to: store a one-to-one mapping relationship between a customized code of a character using each of fonts in the multi-font library and a standard code of the character using the font in the standard font library; and according to a one-to-one mapping relationship between a customized code of a font displayed with respect to each of the characters in the input character sequence in the multi-font library and a standard code of the character using the font in the standard font library, convert the coding sequence corresponding to the input character sequence into a customized coding sequence; and thereby display a character sequence comprising at least one font on the newly created page.

An innovative aspect of the disclosed subject matter includes a non-transitory computer-readable storage medium with an executable program stored thereon, wherein the program, when executed by at least one processor, causes a computing device to perform the steps in the method for forming a multi-font library and the method for displaying different fonts by using a multi-font library.

The following beneficial effects can be achieved:

In some implementations, each of the characters in the multi-font library formed corresponds to at least one font. That is, characters using different fonts are stored and displayed using only one font library (i.e., multi-font library). This implements customized display of different fonts on the same page, prevents the problem in the prior art that a plurality of font libraries need to be configured for displaying different fonts on the same page, reduces storage capacity for storing the font libraries, and improves efficiency of the fonts in the font library. The multi-font library disclosed herein is especially applicable to mobile devices.

### BRIEF DESCRIPTION OF THE DRAWINGS

FIG. 1 is a flowchart of a method for forming a multi-font library;

FIG. 2 is a flowchart of a method for displaying different fonts by using the multi-font library;

FIG. 3 illustrates an example of displaying different fonts in the same document in a mobile operating system by using the method illustrated in FIG. 2;

FIG. 4 is a schematic structural diagram of an apparatus for forming a multi-font library; and

FIG. 5 is a schematic structural diagram of an apparatus for displaying different fonts by using the multi-font library.

### DETAILED DESCRIPTION

To make a person skilled in the art better understand the technical solutions of embodiments of the disclosed subject matter, a method and apparatus for forming a multi-font library, and a method and apparatus for displaying different fonts by using the multi-font library are further described in detail with reference to accompanying drawings and embodiments.

It should be noted that the term “code/coding” as used throughout this document refers to a uniform internal characteristic for arranging characters in a fixed sequence and recording, storing, transferring, and exchanging characters therebased. In this regard, the arrangement sequence of characters is the code/coding.

The term “standard code” refers to the code of a character in a standard font library. Existing international and national coding standards define a plurality of standard font libraries. Each standard font library is capable of storing and displaying only one font, for example, the SimSun font library, the KaiTi font library, the SimHei font library, or the like. In each standard font library, a character has different fonts but the same code. For example, no matter in the SimSun font library, the KaiTi font library, or the SimHei font library, the Chinese character “ [symbol] ” has a uniform code 6211.

The term “customized code” refers to the code in the multi-font library. The multi-font library is capable of storing and displaying a plurality of fonts. Each character corresponds to at least one font and at least one customized code. For example, the Chinese character “ [symbol] ” may correspond to three fonts, SimSun, KaiTi, and SimHei, and each of the SimSun font of “ [symbol] ”, KaiTi font of “ [symbol] ”, and SimHei font of “ [symbol] ” respectively corresponds to a unique customized code.

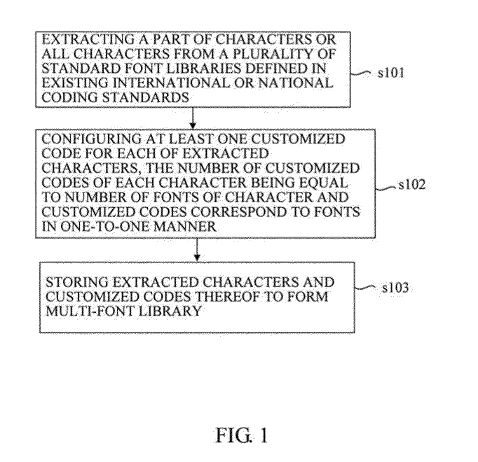

As illustrated in FIG. 1, a method for forming a multi-font library, includes the following steps:

s101 includes extracting a part of characters or all characters from a plurality of standard font libraries defined in existing international or national coding standards. Since the characters are extracted from a plurality of standard font libraries, each of the extracted character corresponds to at least one font.

The standard font library may be the traditional SimSun font library, the KaiTi font library, or the SimHei font library; or may be the Founder JingleiTi font library, the Founder Mew font library, the Founder popular font library, the Founder XuanZhenZhuan variant font library, the Founder NaHanTi font library, Founder KangTi font library, or the like. Here, extracting a part of characters from a plurality of standard font libraries refers to removing some rarely-used characters from each standard font library and extracting only commonly-used characters therefrom, so as to save the storage capacity. Alternatively, from the perspective of convenient use of a user, all characters may be extracted from each standard font library.

The existing international coding standards comprise ISO/IEC 10646:2003, and the existing national coding standards comprise GB18030-2000 and GB13000.1-1993.

s102 includes configuring at least one customized code for each of the extracted characters, wherein the number of customized codes of the each character is equal to the number of fonts of the character and the customized codes correspond to the fonts in a one-to-one manner.

That is, since each of the extracted characters corresponds to at least one font, and a character of each font corresponds to a customized code, each of the extracted characters corresponds to at least one customized code. This facilitates differentiation of different fonts of the same character.

In the characters extracted in step s101, if there exists a character with the number of fonts being equal to 1, the customized code of the character using the font in the multi-font library is configured to be the same as a standard code of the character using the font in the standard font library. For example, in the multi-font library, if only one font is available for the character “ [symbol] ”, no matter what font the character “ [symbol] ” uses, the customized code of the character is identical with the standard code of the character “ [symbol] ” in the standard font library, i.e., 6211.

If there exists a character with the number of fonts being larger than 1, each of the fonts of the character is configured to correspond to a customized code, and the customized code corresponding to each of the fonts of the character is configured to be in a one-to-one mapping relationship with a standard code of the character using the font in the standard font library. For example, two fonts, i.e., the Founder JingleiTi font and the Founder NaHanTi font, are available for the character “ [symbol] ”, and the customized code of the Founder JingleiTi “ [symbol] ” is 9256, and the customized code of the Founder NaHanTi “ [symbol] ” is 9257. In this case, the customized code (9256) of the Founder JingleiTi “ [symbol] ” in the multi-font library is in a one-to-one mapping relationship with the standard code (6211) of the Founder JingleiTi “ [symbol] ” in the Founder JingleiTi font library; and the customized code (9257) of the Founder NaHanTi “ [symbol] ” in the multi-font library is in a one-to-one mapping relationship with the standard code (6211) of the Founder NaHanTi “ [symbol] ” in the Founder NaHanTi font library.

The customized code corresponding to each of the fonts of the character with the number of fonts being larger than 1 may be formed by:

presetting a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and thereby deriving the corresponding customized code of each of the fonts of the character; or

randomly forming the customized code that is corresponding to each of the fonts of the character but different from the standard code of the character using the font in the standard font library.

For example, with respect to the character with the number of fonts being larger than 1, none of the customized codes corresponding to various fonts of the character is identical with the standard code of the character in the standard font library. Certainly, in order to reduce code types, among the customized codes corresponding to the various fonts of the character, it is allowable that the customized code corresponding to one font is identical with the standard code of the font in the standard font library, with the customized codes of remaining fonts being respectively different from the standard code of the character using the font in the standard font library. In this case, the customized codes corresponding to the remaining fonts need to be in one-to-one mapping relationship with the standard code of the character using the remaining fonts in the standard font library.

s103 includes storing the extracted characters and the customized codes thereof to form the multi-font library.

The multi-font library is a TrueType font library, a PostScript font library, or a user-defined font library. The multi-font library may be directly installed on such an operating system as Windows, MAC OS, Unix, Linux, or the like, and thus widely applied in display of computer documents, software interfaces, webpage content, and the like.

It should be noted that, in order to reduce coding workload, in the multi-font library, the customized code of a character using each of the fonts may occupy the code point (position) of a rarely-used character. For example, in the multi-font library, the Founder JingleiTi “ [symbol] ” (i.e., the Founder JingleiTi font of the character “ [symbol] ”) corresponds to the customized code 9256, whereas in the SimSun font, the character corresponding to the standard code that is identical to the customized code is “ [symbol] ”.

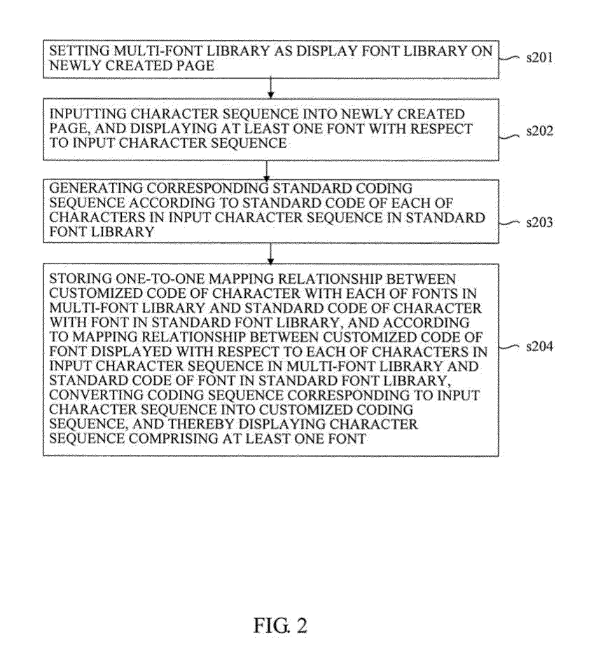

As illustrated in FIG. 2, a method for displaying different fonts by using a multi-font library formed using the above-described method, includes the following steps:

s201 includes setting the multi-font library as a display font library on a newly created page. The page comprises a character-input-supported page, such as a computer document page, a software display page, or a webpage display page;

s202 includes inputting a character sequence into the newly created page, and displaying at least one font with respect to the input character sequence;

s203 includes generating a corresponding standard coding sequence according to a standard code of each of characters in the input character sequence; and

s204 includes storing a one-to-one mapping relationship between a customized code of a character using each of fonts in the multi-font library and a standard code of the character using the font in the standard font library, and according to a one-to-one mapping relationship between a customized code of a font displayed with respect to each of the characters in the input character sequence in the multi-font library and a standard code of the character using the font in the standard font library, converting the standard coding sequence corresponding to the input character sequence into a customized coding sequence, and thereby displaying a character sequence comprising at least one font on the newly created page.

It should be noted that, since the multi-font library may store characters with the number of fonts being larger than 1, and the customized code of the character with the number of fonts being equal to 1 in the multi-font library is identical with the standard code of the character in the standard font library, the mapping relationships stored in step s204 do not comprise a mapping relationship between the customized code of the character with the number of fonts being equal to 1 and the standard code thereof. If the input character sequence comprises the character with the number of fonts being equal to 1, during the process of converting the standard coding sequence corresponding to the input character sequence into the customized coding sequence does not comprise the step of converting the customized code of the character with the number of fonts being equal to 1 into the standard code thereof. To be specific, with respect to the character with the number of fonts being equal to 1, the character may be directly displayed on the newly created page without the code conversion step. That is, the multi-font library to which the above-described method for displaying different fonts is applied may comprise either characters with the number of fonts being larger than 1 or comprise characters with the number of fonts being equal to 1.

In the prior art, a user, if desiring to display a plurality of typefaces (fonts) on the same page, needs to load the plurality of font libraries, and select different font library names for different text paragraphs (character sequences) as required. However, using the multi-font library as a display library, the user is capable of directly displaying a plurality of typefaces on the same page simultaneously neither by selecting the different font library names nor by loading the plurality of font libraries.

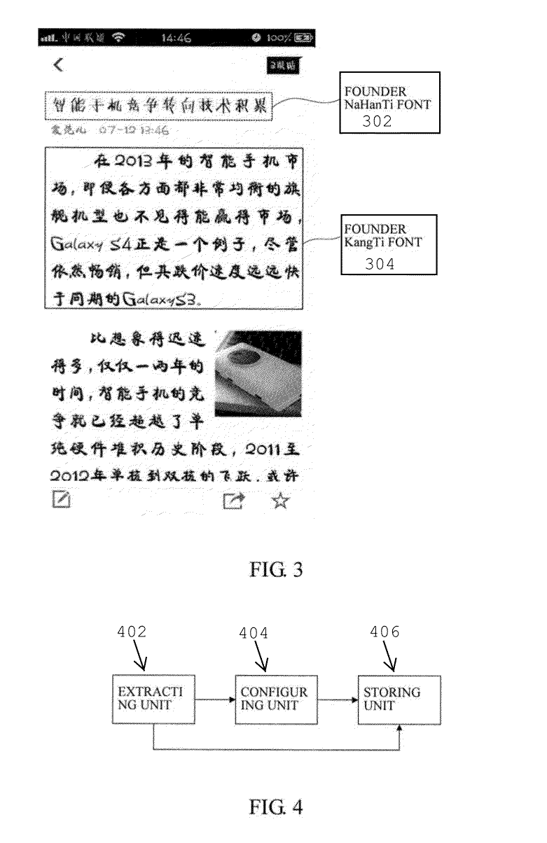

FIG. 3 illustrates an example of displaying the Founder NaHanTi font 302 and the Founder KangTi 304 font simultaneously in one document in a mobile operating system by using the above-described method. The multi-font library achieves a font exhibition effect of what you see is what you get. The curve outline of a font can be unlimitedly scaled up or down, free of deformation, thereby achieving more vivid and visualized display effect. The mobile operating system may be IOS, Android, Symbian, WP, or the like.

As illustrated in FIG. 4, an apparatus for forming a multi-font library, includes: an extracting unit 402, a configuring unit 404, and a storing unit 406.

The extracting unit 402 is configured to extract a part of characters or all characters from a plurality of standard font libraries defined in existing international or national coding standards.

The configuring unit 404 is configured to configure at least one customized code for each of the extracted characters, the number of customized codes of the each character is equal to the number of fonts of the character and the customized codes correspond to the fonts in a one-to-one manner.

The storing unit 406 is configured to store the extracted characters and the customized codes thereof to form the multi-font library.

In some implementations, the configuring unit is further configured to: in the extracted characters,

if there exists a character with the number of fonts being equal to 1, enable the customized code of the character using the font in the multi-font library to be the same as a standard code of the character using the font in the standard font library; or

if there exists a character with the number of fonts being larger than 1, enable each of the fonts of the character to correspond to a customized code, and enable the customized code corresponding to each of the fonts of the character to be in a one-to-one mapping relationship with a standard code of the character using the font in the standard font library.

The configuring unit can be further configured to:

preset a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and thereby derive the corresponding customized code of each of the fonts of the character; or

randomly form the customized code that is corresponding to each of the fonts of the character but different from the standard code of the character using the font in the standard font library.

The existing international coding standards include ISO/IEC 10646:2003, and the existing national coding standards include GB18030-2000 and GB13000.1-1993.

In some implementations, the multi-font library is a TrueType font library, a PostScript font library, or a user-defined font library.

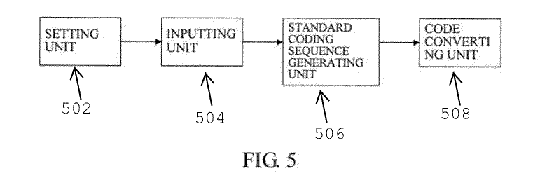

As illustrated in FIG. 5 an apparatus for displaying different fonts by using a multi-font library formed by the above-described apparatus for forming a multi-font library, can include: a setting unit 502, an inputting unit 504, a standard coding sequence generating unit 506, and a code converting unit 508.

The setting unit 502 is configured to set the multi-font library as a display font library on a newly created page.

The inputting unit 504 is configured to input a character sequence into the newly created page, and display at least one font with respect to the input character sequence.

The standard coding sequence generating unit 506 is configured to generate a corresponding standard coding sequence according to a standard code of each of characters in the input character sequence in a standard font library.

The code converting unit 508 is configured to: store a one-to-one mapping relationship between a customized code of a character using each of fonts in the multi-font library and a standard code of the character using the font in the standard font library; and according to a one-to-one mapping relationship between a customized code of a font displayed with respect to each of the characters in the input character sequence in the multi-font library and a standard code of the character using the font in the standard font library, convert the coding sequence corresponding to the input character sequence into a customized coding sequence; and thereby display a character sequence comprising at least one font on the newly created page.

Implementations of the disclosed subject matter include methods for displaying different fonts by using a multi-font library formed as discussed above, wherein a character sequence can be “ [symbol] (I LOVE YOU)”. In the multi-font library a plurality of fonts are available for each of the characters “ [symbol] (I)”, “ [symbol] (LOVE)”, and “ [symbol] (YOU)”, and the Founder JingleiTi “ [symbol] ”, the Founder XuanZhenZhuan variant “ [symbol] ”, and the Founder CuHuoYiTi “ [symbol] ” need to be displayed on a newly created page.

In some implementations, the methods comprise the following steps:

s301 includes setting the multi-font library as a display font library on a newly created page;

S302 includes inputting the character sequence “ [symbol] ” into the newly created page;

s203 includes generating a corresponding standard coding sequence “6211, 7231, 4F60” according to standard codes of characters in the input character sequence “ [symbol] ”; and

s304 includes storing a one-to-one mapping relationship between a customized code of a character using each of fonts in the multi-font library and a standard code of the character using the font in the standard font library, and according to a one-to-one mapping relationship between a customized code of a font displayed with respect to each of the characters in the input character sequence “ [symbol] ” in the multi-font library and a standard code of the character using the font in the standard font library, converting the standard coding sequence “6211, 7231, 4F60” corresponding to the input character sequence “ [symbol] ” into a customized coding sequence “9256, 85A0, 201A6”, and thereby displaying the Founder JingleiTi “ [symbol] ”, the Founder XuanZhenZhuan variant “ [symbol] ”, and the Founder CuHuoYiTi “ [symbol] ” on the newly created page.

Table 1 lists the corresponding standard codes of the characters “ [symbol] ”, “ [symbol] ”, and “ [symbol] ”, the corresponding customized codes of the characters in the multi-font library, the corresponding fonts of the customized codes in the multi-font library, the corresponding font names of the fonts corresponding to the customized codes, and the corresponding fonts of the standard codes identical to the customized codes in the SimSun font library.

TABLE 1

| | | | Font | | Corresponding |
|---|---|---|---|---|---|
| | | | Corresponding | | Font in |
| | Standard | Customized | to Customized | Corresponding | SimSun Font |
| Character | Code | Code | Code | Font Name | Library |
| [symbol] (I) | 6211 | 9256 | [symbol] | Founder | [symbol] |
| | | | | JingleiTi font | |
| [symbol] (love) | 7231 | 85A0 | [symbol] | Founder | [symbol] |
| | | | | XuanZhenZhuan | |
| | | | | variant font | |
| [symbol] (you) | 4F60 | 201A6 | [symbol] | Founder | [symbol] |
| | | | | CuHuoYiTi font | |

Other methods and functions of these implementations can include those discussed above, which are thus not described herein any further.

Some implementations include a method for displaying different fonts by using a multi-font library formed using methods described above, wherein a character sequence can include “ [symbol] (I LOVE YOU)”. In the multi-font library, only one font is available for each of the characters “ [symbol] (I)”, “ [symbol] (LOVE)”, and “ [symbol] (YOU)”, and on a newly created page the Founder JingleiTi “ [symbol] ”, the Founder XuanZhenZhuan variant “ [symbol] ”, and the Founder CuHuoYiTi “ [symbol] ”. Only the Founder JingleiTi font is available for the character “ [symbol] ”; only the Founder XuanZhenZhuan variant font is available for the character “ [symbol] ”; only the Founder CuHuoYiTi font is available for the character “ [symbol] ”; and the Founder JingleiTi “ [symbol] ”, the Founder XuanZhenZhuan variant “ [symbol] ”, and the Founder CuHuoYiTi “ [symbol] ” need to be displayed on a newly created page.

Different from the methods described above, the method described in this implementation does not include step s304. To be specific, according to the method described with respect to these implementations, the Founder JingleiTi “ [symbol] ”, the Founder XuanZhenZhuan variant “ [symbol] ”, and the Founder CuHuoYiTi “ [symbol] ” may be directly displayed on the newly created page without the need of converting a standard coding sequence into a customized coding sequence. This is because only one font is available for each of the characters “ [symbol] ”, “ [symbol] ”, and “ [symbol] ” in the multi-font library. Therefore, different fonts of the same character do not need to be differentiated, and the customized code of each of the characters “ [symbol] ”, “ [symbol] ”, and “ [symbol] ” in the multi-font library is identical with the standard code of the character in a standard font library. Accordingly, the characters “ [symbol] ”, “ [symbol] ”, and “ [symbol] ” only need to be stored in the multi-font library in a sequence of standard codes thereof.

Table 2 lists the corresponding standard codes of the characters “ [symbol] ”, “ [symbol] ”, and “ [symbol] ”, the corresponding fonts in the multi-font library, and the corresponding font names.

TABLE 2

| | Standard | Font Displayed in | Corresponding Font |
|---|---|---|---|
| Character | Code | Mulli-Font Library | Name |
| [symbol] (I) | 6211 | [symbol] | Founder JingleiTi font |
| [symbol] (love) | 7231 | [symbol] | Founder XuanZhenZhuan |
| | | | variant font |
| [symbol] (you) | 4F60 | [symbol] | Founder CuHuoYiTi font |

It should be understood that described above are only illustrative embodiments for description of principles of the present invention, but are not intended to limit the present invention. Persons of ordinary skill in the art may derive various variations and improvements without departing from the spirit and essence of the present invention, and such variations and improvements should all fall within the protection scope of the present invention.

What is claimed is:

1. A method for forming a multi-font library, comprising the following steps:
A1. extracting a part of characters or all characters from a plurality of standard font libraries defined in existing international or national coding standards;
A2. configuring at least one customized code for each of the extracted characters, wherein the number of customized codes of the each character is equal to the number of fonts of the character and the customized codes correspond to the fonts in a one-to-one manner; and
A3. storing the extracted characters and the customized codes thereof to form the multi-font library.

2. The method according to claim 1, wherein step A2 comprises: in the characters extracted in step A1,
if there exists a character with the number of fonts being equal to 1, enabling the customized code of the character using the font in the multi-font library to be the same as a standard code of the character using the font in the standard font library; or
if there exists a character with the number of fonts being larger than 1, enabling each of the fonts of the character to correspond to a customized code, and enabling the customized code corresponding to each of the fonts of the character to be in a one-to-one mapping relationship with a standard code of the character using the font in the standard font library.

3. The method according to claim 2, wherein
the customized code corresponding to each of the fonts of the character with the number of fonts being larger than 1 is formed by:
presetting a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and thereby deriving the corresponding customized code of each of the fonts of the character; or
randomly forming the customized code that is corresponding to each of the fonts of the character but different from the standard code of the character using the font in the standard font library.

4. The method according to claim 1, wherein
the existing international coding standards comprise ISO/IEC 10646:2003, and the existing national coding standards comprise GB18030-2000 and GB13000.1-1993; and
the multi-font library is a TrueType font library, a PostScript font library, or a user-defined font library.

5. A method for displaying different fonts by using a multi-font library, comprising the following steps:
B1. setting the multi-font library as a display font library on a newly created page;
B2. inputting a character sequence into the newly created page, and displaying at least one font with respect to the input character sequence;
B3. generating a corresponding standard coding sequence according to a standard code of each of characters in the input character sequence in a standard font library; and
B4. storing a one-to-one mapping relationship between a customized code of a character using each of fonts in the multi-font library and a standard code of the character using the font in the standard font library, and according to a one-to-one mapping relationship between a customized code of a font displayed with respect to each of the characters in the input character sequence in the multi-font library and a standard code of the character using the font in the standard font library, converting the standard coding sequence corresponding to the input character sequence into a customized coding sequence, and thereby displaying a character sequence comprising at least one font on the newly created page.

6. An apparatus for forming a multi-font library, comprising: an extracting unit, a configuring unit, and a storing unit; wherein
the extracting unit is configured to extract a part of characters or all characters from a plurality of standard font libraries defined in existing international or national coding standards;
the configuring unit is configured to configure at least one customized code for each of the extracted characters, wherein the number of customized codes of the each character is equal to the number of fonts of the character and the customized codes correspond to the fonts in a one-to-one manner; and
the storing unit is configured to store the extracted characters and the customized codes thereof to form a multi-font library.

7. The apparatus according to claim 6, wherein the configuring unit is configured to: in the characters extracted by the extracting unit,
if there exists a character with the number of fonts being equal to 1, enable the customized code of the character using the font in the multi-font library to be the same as a standard code of the character using the font in the standard font library; or
if there exists a character with the number of fonts being larger than 1, enable each of the fonts of the character to correspond to a customized code, and enable the customized code corresponding to each of the fonts of the character to be in a one-to-one mapping relationship with a standard code of the character using the font in the standard font library.

8. The apparatus according to claim 7, wherein the configuring unit is further configured to:
preset a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and
thereby derive the corresponding customized code of each of the fonts of the character; or randomly form the customized code that is corresponding to each of the fonts of the character but different from the standard code of the character using the font in the standard font library.

9. The apparatus according to claim 6, wherein
the existing international coding standards comprise ISO/IEC 10646:2003, and the existing national coding standards comprise GB18030-2000 and GB13000.1-1993; and
the multi-font library is a TrueType font library, a PostScript font library, or a user-defined font library.

10. A apparatus for displaying different fonts by using a multi-font library, comprising: a setting unit, an inputting unit, a standard coding sequence generating unit, and a code converting unit; wherein
the setting unit is configured to set the multi-font library as a display font library on a newly created page;
the inputting unit is configured to input a character sequence into the newly created page, and display at least one font with respect to the input character sequence;
the standard coding sequence generating unit is configured to generate a corresponding standard coding sequence according to a standard code of each of characters in the input character sequence in a standard font library; and
the code converting unit is configured to: store a one-to-one mapping relationship between a customized code of a character using each of fonts in the multi-font library and a standard code of the character using the font in the standard font library; and according to a one-to-one mapping relationship between a customized code of a font displayed with respect to each of the characters in the input character sequence in the multi-font library and a standard code of the character using the font in the standard font library, convert the coding sequence corresponding to the input character sequence into a customized coding sequence; and thereby display a character sequence comprising at least one font on the newly created page.

11. A non-transitory computer-readable storage medium with an executable program stored thereon, wherein the program, when executed by at least one processor, causes a computing device to perform the following steps:
A1. extracting a part of characters or all characters from a plurality of standard font libraries defined in existing international or national coding standards;
A2. configuring at least one customized code for each of the extracted characters, wherein the number of customized codes of the each character is equal to the number of fonts of the character and the customized codes correspond to the fonts in a one-to-one manner; and
A3. storing the extracted characters and the customized codes thereof to form a multi-font library.

12. The non-transitory computer-readable storage medium according to claim 11, wherein step A2 comprises: in the characters extracted in step A1,
if there exists a character with the number of fonts being equal to 1, enabling the customized code of the character using the font in the multi-font library to be the same as a standard code of the character using the font in the standard font library; or
if there exists a character with the number of fonts being larger than 1, enable each of the fonts of the character to correspond to a customized code, and enable the customized code corresponding to each of the fonts of the character to be in a one-to-one mapping relationship with a standard code of the character using the font in the standard font library.

13. The non-transitory computer-readable storage medium according to claim 12, wherein
the customized code corresponding to each of the fonts of the character with the number of fonts being larger than 1 is formed by:
presetting a function relation one-to-one corresponding to each of the fonts of the character, wherein in the function relation corresponding to each of the fonts, the standard code of the character using the font in the standard font library is an independent variable of the function, and the customized code corresponding to the font is a dependent variable thereof; and thereby deriving the corresponding customized code of each of the fonts of the character; or
randomly forming the customized code that is corresponding to each of the fonts of the character but different from the standard code of the character using the font in the standard font library.

14. The non-transitory computer-readable storage medium according to claim 11, wherein
the existing international coding standards comprise ISO/IEC 10646:2003, and the existing national coding standards comprise GB18030-2000 and GB13000.1-1993; and
the multi-font library is a TrueType font library, a PostScript font library, or a user-defined font library.

15. A non-transitory computer-readable storage medium with an executable program stored thereon, wherein the program, when executed by at least one processor, causes a computing device to perform the following steps:
B1. setting the multi-font library as a display font library on a newly created page;
B2. inputting a character sequence into the newly created page, and displaying at least one font with respect to the input character sequence;
B3. generating a corresponding standard coding sequence according to a standard code of each of characters in the input character sequence in a standard font library; and
B4. storing a one-to-one mapping relationship between a customized code of a character using each of fonts in the multi-font library and a standard code of the character using the font in the standard font library, and according to a one-to-one mapping relationship between a customized code of a font displayed with respect to each of the characters in the input character sequence in the multi-font library and a standard code of the character using the font in the standard font library, converting the standard coding sequence corresponding to the input character sequence into a customized coding sequence, and thereby displaying a character sequence comprising at least one font on the newly created page.
